(19) United States
(12) Patent Application Publication
(10) Pub. No.: US 2017/0259863 A1
(43) Pub. Date: Sep. 14, 2017

(54) Motorcycle Loading Device

(71) Applicant: Cycle Caddy, LLC, Palm Harbor, FL (US)

(72) Inventors: Fred Ferderber, Palm Harbor, FL (US); David Tieche, Palm Harbor, FL (US)

(21) Appl. No.: 15/064,712

(22) Filed: Mar. 9, 2016

(51) Int. Cl. B62H 3/08; B60P 3/075

(52) U.S. Cl. CPC B62H 3/08; B60P 3/075; B62H 2700/00

(57) ABSTRACT

This invention comprises a motorcycle loading apparatus comprising a first angled receiving platform, a second angled receiving platform, a u-shaped connector between the first angled receiving platform and the second angled receiving platform which allows the first angled receiving platform and the second angled receiving platform to become displaced, a first tire support, a second tire support, a connector between the first tire support and the second tire support, a first base connecting the first angled receiving platform to the first tire support, a second base connecting the second angled receiving platform to the second tire support, a first and second tire engaging member, and at least one wheel attached to the first and second base. The invention also describes a method of loading a motorcycle into the motorcycle loading apparatus.

### BACKGROUND OF THE INVENTION

Field of the Invention

The present invention relates to an apparatus and method for the loading and storage of vehicles. More precisely, the present invention relates to a moveable apparatus and method for the loading and storage of motorcycles.

Description of the Background Art

Presently, motorcycles require a kickstand to remain upright when a rider is not riding due to the balance structure of the vehicle. The kickstand allows for the motorcycle to remain upright and prevents the motorcycle from tipping and causing damage. However, the kickstand does not allow for the motorcycle to be easily and reliably moved around once in position. A rider is normally forced to take the kickstand out of position, re-position the motorcycle, then put the kickstand back down. The rider is further limited by the design of the motorcycle itself as a vehicle with two wheels inherently has a more limited range of motion than a vehicle having more wheels. Moving a motorcycle can be cumbersome, especially when attempting to park one in a garage, and the present invention seeks to provide an apparatus that allows for easier movement.

There presently exists a need for a device that allows motorcycle riders to load their motorcycle such that it remains upright and which allows for ease of motion once loaded.

Therefore, it is an object of this invention to provide an improvement which overcomes the aforementioned inadequacies and provides an improvement which is a significant contribution to the advancement of the motorcycle storage art.

Another object of this invention is to provide an apparatus which reliably allows for the loading of motorcycles in an upright position.

Another object of this invention is to provide an apparatus which allows for a motorcycle loaded into the apparatus to have a range of movement previously unavailable to a motorcycle being held upright by a kickstand.

Another object of this invention is to provide a method for using the apparatus described herein.

The foregoing has outlined some of the pertinent objects of this invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a motorcycle loading apparatus comprising a first angled receiving platform, a second angled receiving platform, a connector/hinge between the first angled receiving platform and the second angled receiving platform which allows the first angled receiving platform and the second angled receiving platform to become displaced, a first tire support, a second tire support, a connector/hinge between the first tire support and the second tire support, a first base connecting the first angled receiving platform to the first tire support, a second base connecting the second angled receiving platform to the second tire support, a first and second tire engaging member and at least one wheel attached to the first and second base.

This invention also comprises a method of loading a motorcycle comprising placing the motorcycle loading device described above on a flat surface in a first position, angling the motorcycle loading device such that the first angled receiving platform and the second angled receiving platform are substantially parallel with the flat surface, resulting in a second position, and pushing a motorcycle having a front wheel and a rear wheel into engagement with the first angled receiving platform and the second angled receiving platform while in the second position until the motorcycle loading device returns to the first position such that either the front wheel or the rear wheel comes into contact with the first tire support and the second tire support which causes the first tire support and second tire support to engage the rear wheel and maintain the rear wheel in a stationary position.

In accordance with one embodiment, the first and second angled receiving platforms are preferably triangularly shaped with a triangular gap in between the two platforms. This allows for the motorcycle wheel to be guided onto the first and second angled receiving platforms. Then, once the wheel has been guided into place and contacts the first and second tire supports, the first and second tire supports as well as the first and second tire engaging members engage the tire and maintain the tire in a stationary position. The receiving platforms are preferably triangular but any equivalent configuration, whether known or yet to be developed, which allows a wheel to be guided onto the platforms are intended to be included herein.

In accordance with one embodiment, the connector between the first angled receiving platform and the second angled receiving platform and between the first tire support and second tire support preferably has a u-shaped structure with a pair of horizontally protruding flanges which allow for the first and second angled receiving platforms as well as the tire supports to displace when a weight is placed in between them. For example, the weight of a motorcycle would cause the tire supports and tire engaging members to close inward and engage the rear tire of the motorcycle so as to lock it in place and maintain its position. Additionally, the width between the first and second base should be such that a tire would fit between the first and second base.

In accordance with another embodiment, the apparatus is made of a material that can withstand the weight of all types of motorcycles and vehicles but is still lightweight enough to be carried around by the average consumer. The apparatus is also preferably small enough to be stored efficiently. This storage can be in a multitude of places such as a rider's garage, a closet, or even a large motorcycle saddlebag.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures and methods for carrying out the same purposes of the present invention. It should also be realized by those skilled in the art that such equivalent constructions and methods do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 illustrates a side perspective view of the loading device.

FIG. 2 illustrates a side view of the loading device in position to receive a tire.

FIG. 3 illustrates a side view of the loading device with a tire in position.

FIG. 4 illustrates a top perspective view of the loading device.

FIG. 5 illustrates a bottom perspective view of the loading device.

FIG. 6 illustrates a top perspective view of the preferred embodiment of the loading device.

FIG. 7 illustrates a close-up view of the hinge.

FIG. 8A illustrates a cross-sectional view of the loading device without a tire in position.

FIG. 8B illustrates a cross-sectional view of the loading device with a tire in position.

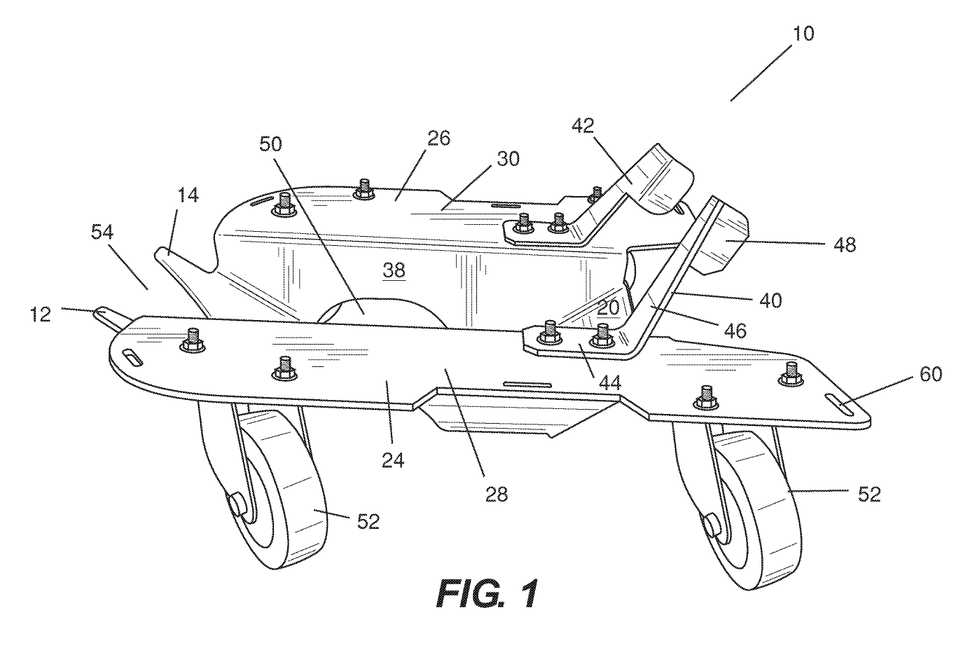

Similar reference characters refer to similar parts throughout the several views of the drawings.

### DETAILED DESCRIPTION OF THE PREFERRED EMBODIMENT

The following description is of a preferred embodiment presently contemplated for carrying out the invention. This description is not to be taken in a limiting sense, but is made merely for the purpose of describing one or more preferred embodiments of the invention. The scope of the invention should be determined with reference to the claims.

As shown in the accompanying drawings, for purposes of illustration, the present invention uses specific methods and technologies for the loading of motorcycles such that they no longer need to rely on a kickstand to remain upright and to provide better mobility while in a loaded upright position.

The motorcycle loading device 10 as shown comprises a first angled receiving platform 12 and second angled receiving platform 14. The first angled receiving platform 12 and second angled receiving platform 14 are connected by a substantially u-shaped connector/hinge 16. The hinge 16 has a pair of flanges 18 which flare out horizontally so as to secure the first angled receiving platform 12 and second angled receiving platform 14 together. The loading device 10 also comprises a first tire support 20 and second tire support 22. The first tire support 20 and second tire support 22 are likewise connected by a substantially u-shaped connector/hinge 16. The first and second angled receiving platforms 12, 14 are also connected to the first and second tire supports 20, 22 by a first base 24 and second base 26, each of which further comprise a first and second base top 28, 30, a first and second base bottom 32, 34, and a first and second vertically disposed base side 36, 38. The first angled receiving platform 12 and first tire support 20 are connected to the first base side 34 and the second angled receiving platform 14 and second tire support are connected to the second base side 36. The loading device 10 further comprises a first and second wheel engaging member 40, 42 to provide support a tire 58 for when a tire 58 is engaged with the loading device 10. The first wheel engaging member 40 further comprises a first, substantially horizontally disposed, section 44 which extends along the first base top 28, a second angled section 46 attached to the first section 44 which is generally angled away from the first and second receiving platforms 12, 14, and a third rearward facing flange 48 attached to the second section 46. The second wheel engaging member 42 is similarly situated with a first, substantially horizontally disposed, section 44 which extends along the second base top 30, a second angled section 46 attached to the first section 44 which is generally angled away from the first and second receiving platforms 12, 14, and a third rearward facing flange 48 attached to the second section 46. The retention well 50 between the first and second angled receiving platforms 12, 14 and the first and second wheel engaging members 40, 42 is preferably deep and wide enough to receive a standard motorcycle tire but can be any appropriate width to receive a tire 58. The loading device 10 is generally moveable through the use of a series of wheels 52 attached to the first and second base bottom 32, 34 through the use of nuts and bolts, screws, or any other known or unknown physical connection means. Preferably, the loading device 10 features a type of handle 60 to provide for the ability to carry the loading device 10.

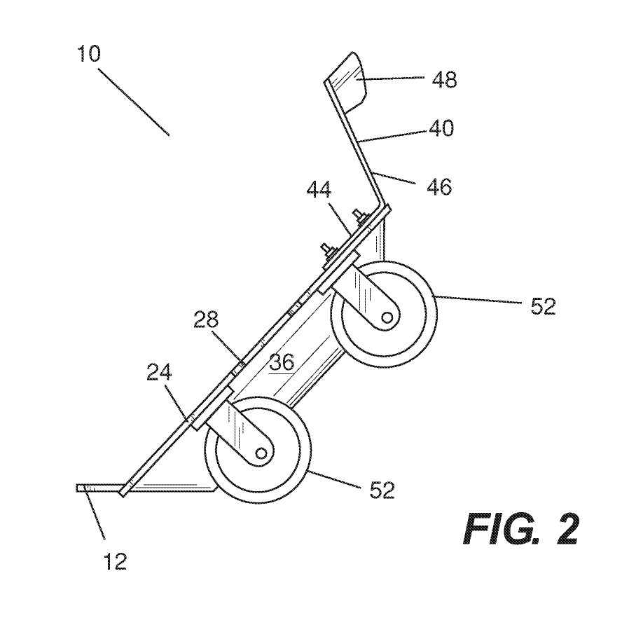

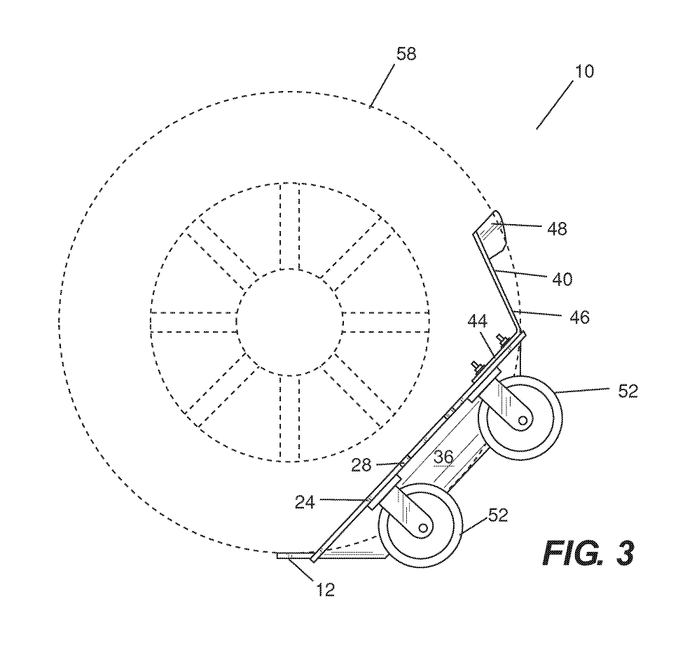

FIG. 2 shows the loading device 10 in the second position ready to receive a tire 58. This position creates the proper angle for the loading device 10 to safely receive a tire 58. The first and second angled receiving platforms 12, 14 provide a flat surface such that when the loading device 10 is tipped forward the device lays flat against the ground. Then, as FIG. 3 shows, the tire 58 can be guided into the retention well 50 by the first and second angled receiving platforms 12, 14.

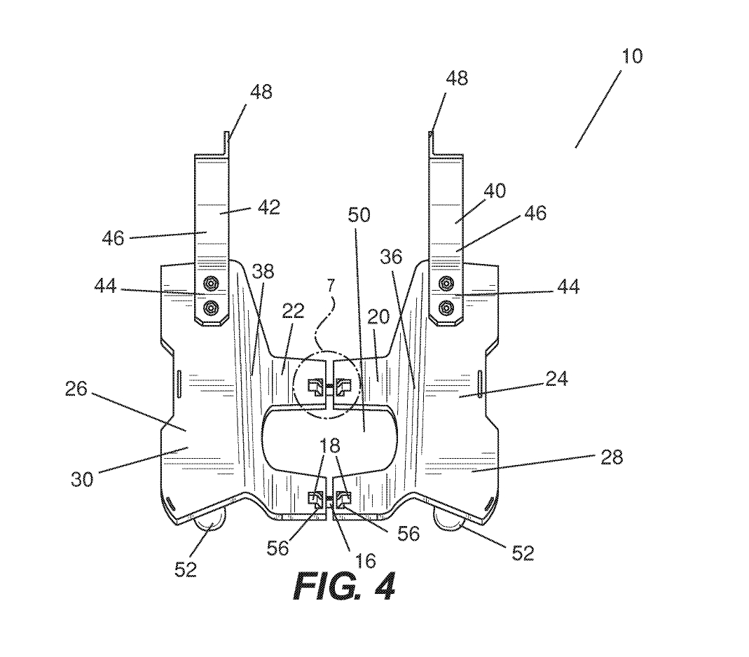

FIG. 4 shows a top perspective view of the loading device 10. In this alternative embodiment, the first and second angled receiving platforms 12, 14 are not present. This does not prevent the tire 58 from entering the retention well 50 but does make it more difficult.

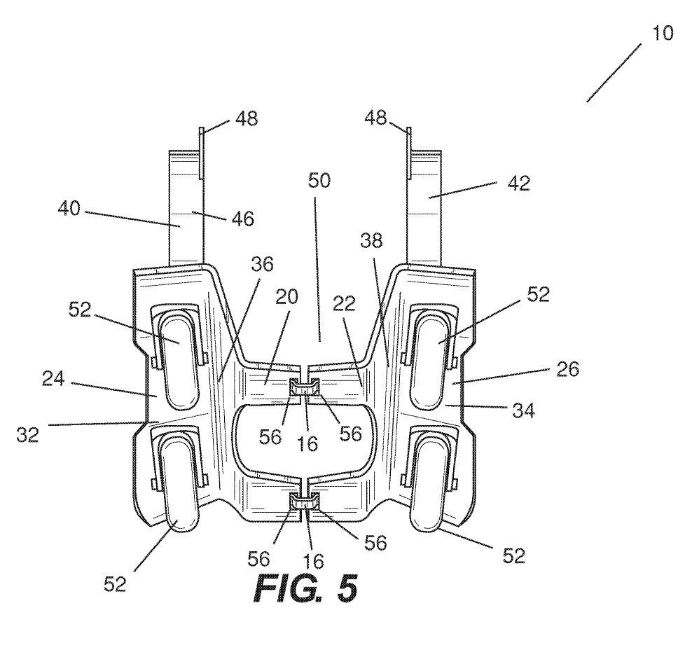

FIG. 5 shows a bottom perspective view of the loading device 10. As can be seen in the figure, the series of wheels 52 are of the type usually used for dollies and similar apparatuses used to move heavy goods. Any wheel system that could adequately support the weight of a motorcycle or vehicle would be appropriate.

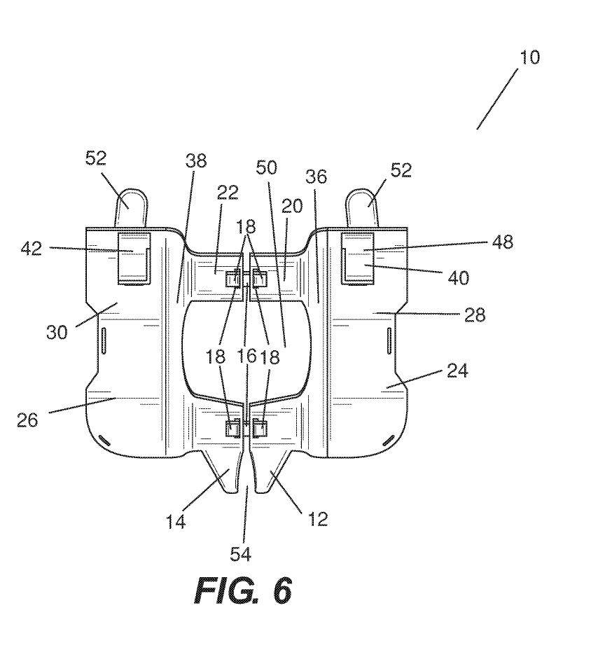

FIG. 6 shows another top perspective view of the loading device 10. This perspective shows the first and second angled receiving platforms 12, 14 and their preferred orientation. This orientation preferably includes a gap 54 between the first and second angled receiving platforms 12, 14 that helps guide the tire 58 into the retention well 54.

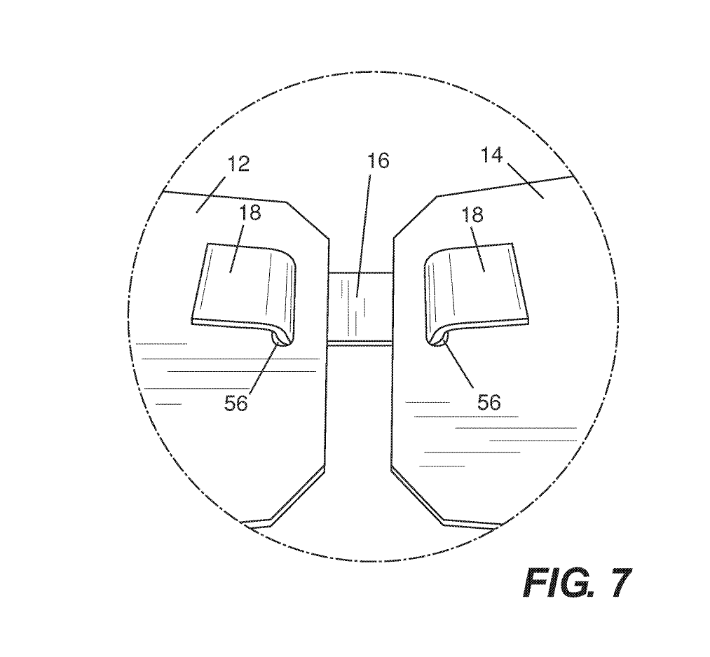

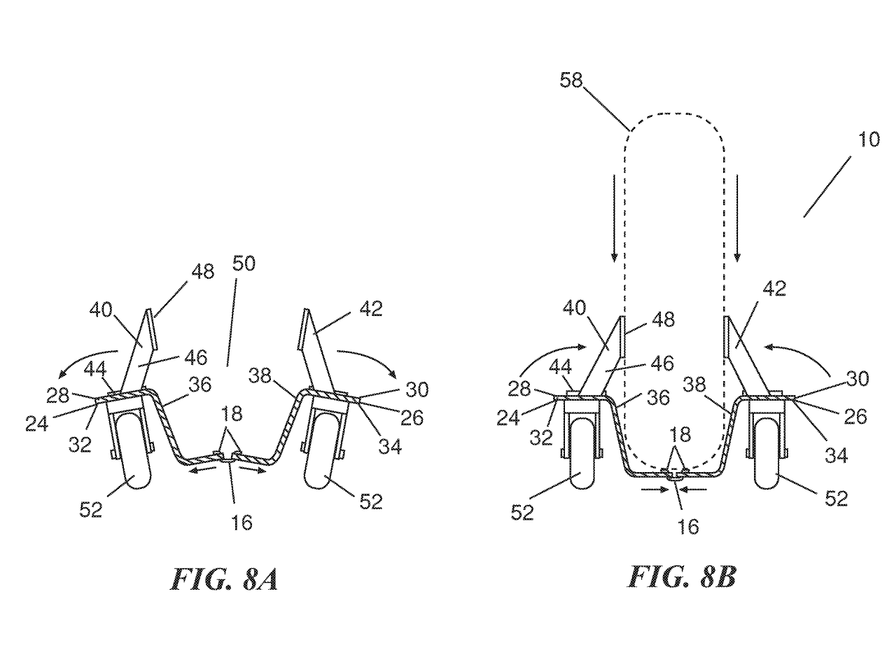

FIG. 7 is a close-up view of the connector/hinge 16. The connector/hinge 16 is preferably u-shaped and fits loosely into hinge slots 56. The loose fitting allows for the motion shown in FIGS. 8A and 8B. Specifically, prior to the time when a tire 58 enters the retention well 54, as shown in FIG. 8A, the loading device 10 splays generally outward. And, as shown in FIG. 8B, when a tire 58 enters the retention well 54 and the loading device 10 is returned to its first, upright position parallel to the ground such that all wheels 52 are touching the ground, the weight of the tire 58, as well as the weight of the vehicle to which it is attached, causes the two sides of the loading device 10 to clamp down on the tire 58. The loading device 10 could also be used to move tires that are not attached to any specific vehicle. The first and second wheel engaging members 40, 42 then move inwardly to engage the tire 58 and prevent the tire 58 from falling out of the retention well 54. The wheels 52 then allow for range of movement once the tire 58 is in place.

The invention being described, it will be obvious that the same may be varied in many ways. Such variations are not to be regarded as a departure from the spirit and scope of the invention, and all such modifications as would be obvious to one of ordinary skill in the art are intended to be included within the scope of the following claims.

What is claimed is:

1. A motorcycle stabilization apparatus comprising:
a pair of tire platforms, each tire platform comprising:
a body;
a front;
a top; and
a bottom;
a substantially angled receiving member integrated into the front of the tire platform wherein when the tire platform is tilted downward, the angled receiving member stabilizes the apparatus on the ground in order to receive a motorcycle tire;
a tire support integrated into the body of the tire platform, the tire support comprising:
a shape configured to engage a portion of the motorcycle tire; and
a pair of receiving slots;
a wheel engagement member connected to the top of the tire platform and comprising:
an angled section; and
a rearward facing member wherein the rearward facing member stabilizes the motorcycle wheel;
a tire platform wheel attached to the bottom of the tire platform; and
a pair of tire platform connectors, each tire platform connector comprising:
a substantially U-shaped connector comprising:
a proximal portion; and
a first distal end and a second distal end, each distal end having a protruding flange, the first protruding flange configured to interconnect into the receiving slot of the first tire platform and the second protruding flange configured to interconnect into the receiving slot of the second tire platform, wherein the tire platform connectors connect the pair of tire platforms and permit the pair of tire platforms to become displaced.

2. A vehicle stabilization apparatus comprising:
at least one connector;
a pair of platforms, each platform comprising
a receiving member; and
a tire support comprising a vehicle engagement member;
a slot for receiving the connector, wherein the connector attaches the pair of platforms and permits the platforms to become displaced.

3. The motorcycle loading apparatus of claim 2 wherein the connection further comprises a proximal end and a distal end with a pair of protruding flanges at the distal end.

4. The motorcycle loading apparatus of claim 2 wherein the width between the pair of bases is greater than or equal to that of a tire.

5. The motorcycle loading apparatus of claim 2 wherein the pair of receiving platforms form a triangular gap to help guide a wheel into the apparatus.

6. The motorcycle loading apparatus of claim 2 wherein the pair of tire engaging members each further comprise a first, substantially horizontally disposed, section extending along the first base, the first section having a thickness, a second, upwardly angled, section which is attached to the first section along a distal edge of the first section and angled towards the first tire support, the second section having a thickness, and a third, rearward facing, section which is attached to the second section along an upper edge, the third section having a thickness.

7. The motorcycle loading apparatus of claim 7 wherein the thickness of the first section, second section, and third section is equal.

8. The motorcycle loading apparatus of claim 2 wherein the pair of bases further comprise a handle at the distal end.

9. The motorcycle loading apparatus of claim 2 wherein the connector is substantially U-shaped.

10. A method for stabilizing a motorcycle comprising:
placing a motorcycle loading device on a flat surface in a first position, the motorcycle loading device comprising:
a pair of tire platforms, each tire platform comprising:
a body;
a front;
a top; and
a bottom;
a receiving member integrated into the front of the tire platform;
a tire support integrated into the body of the tire platform, the tire support comprising:
a shape configured to engage a portion of the motorcycle tire; and
a pair of receiving slots;
a wheel engagement member connected to the top of the tire platform and comprising:
an angled section; and
a rearward facing member wherein the rearward facing member stabilizes the motorcycle wheel;
a tire platform wheel attached to the bottom of the tire platform; and
a pair of tire platform connectors, each tire platform connector comprising:
a proximal portion;
a first distal end;
and a second distal end, each distal end having a protruding flange, the first protruding flange configured to interconnect into the receiving slot of the first tire platform and the second protruding flange configured to interconnect into the receiving slot of the second tire platform, wherein the tire platform connectors connect the pair of tire platforms and permit the pair of tire platforms to become displaced;
angling the motorcycle loading device such that the first angled receiving platform and the second angled receiving platform are substantially parallel with the flat surface, resulting in a second position;
rolling a motorcycle having a front wheel and a rear wheel into engagement with the first and second angled receiving platform while in the second position until the motorcycle loading device returns to the first position such that wheel comes into contact with the first and second tire support; and
engaging the rear wheel with the first tire support, second tire support, first wheel engaging member, and second wheel engaging member.

11. The motorcycle stabilizing method of claim 10 wherein the connection between the pair of receiving platforms further comprises a proximal end and a distal end with a pair of protruding flanges at the distal end and which is substantially u-shaped.

12. The motorcycle stabilizing method of claim 10 wherein the width between the pair of bases is wide enough to receive a motorcycle tire.

13. The motorcycle loading method of claim 10 wherein the pair of receiving platforms form a triangular gap to help guide a motorcycle wheel into the apparatus.

14. The motorcycle stabilizing method of claim 10 wherein the pair of tire engaging members each further comprise a first, substantially horizontally disposed, section extending along the first base, the first section having a thickness, a second, upwardly angled, section which is attached to the first section along a distal edge of the first section and angled towards the first tire support, the second section having a thickness, and a third, rearward facing, section which is attached to the second section along an upper edge, the third section having a thickness.

15. The motorcycle stabilizing method of claim 14 wherein the thickness of the first section, second section, and third section is equal.

16. The motorcycle stabilizing method of claim 10 wherein the connector is substantially U-shaped.

17. The motorcycle stabilizing method of claim 10 wherein the pair of bases further comprise a handle at the distal end.
